(19) United States
(12) Patent Application Publication
(10) Pub. No.: US 2007/0183319 A1
(43) Pub. Date: Aug. 9, 2007

(54) Communication system with redundant communication

(76) Inventors: Volker Rug, Michelstadt (DE); Jochen Kuebert, Karlstadt (DE); Stephan Schultze, Lohr am Main (DE)

Correspondence Address: MICHAEL J. STRIKER, 103 EAST NECK ROAD, HUNTINGTON, NY, 11743, US

(21) Appl. No.: 10/549,588

(22) PCT Filed: Mar. 11, 2004
(86) PCT No.: PCT/DE04/00485

§ 371 Date: May 22, 2006

(30) Foreign Application Priority Data
Mar. 22, 2003 (DE) 103 12 907.3

(51) Int. Cl. H04J 3/14; H04L 12/56

(52) U.S. Cl. 370/228; 370/406

(57) ABSTRACT

The invention relates to a subscriber (1) for using in a communication system, and to a communication system (5) which, at least in a partial section, has redundant communication for increasing the fault tolerance, the communication system being simultaneously highly dynamic. Said communication system comprises, at least in one section, at least two communication paths (10, 20) which are preferably arranged according to a double ring topology. The inventive subscriber comprises one processing unit (11, 21) per communication path, for processing the information signals obtained by means of the respective communication path and/or for producing and sending information signals via the respective communication path. Furthermore, a first activatable coupling (13, 22) is arranged in the subscriber, between the first communication path (10) and the second communication path (20), in such a way that, when the coupling is activated, the information signals are tapped from the first communication path (10) and supplied to the second communication path (20). According to the invention, the supply of the activatable coupling in the subscriber is carried out in the signal feeding direction, downstream of the processing unit (21) of the second communication path (20).

The invention relates to a participant for use in a communication system, and to a communication system of this kind, having redundant communication in at least one portion for increasing the error tolerance, with simultaneously high dynamics of the communication system.

### PRIOR ART

Communication systems are found in many industrial applications. For instance, centrally or noncentrally controlled distributed communication systems are used for instance in automation systems with noncentralized control and drive technology, in which often many individual systems are controlled and driven in a chronologically synchronized way. Such an individual system may be a drive unit, for instance a synchronous or an asynchronous motor, with which one of a plurality of shafts interpolated with one another or operating in a way closely coupled with one another, are driven. Typical applications of such automation systems with noncentralized control and drive technology are printing presses and machine tools as well as robot systems, with many delivery and working elements operating in a chronologically adapted way relative to one another.

Distributed communication systems include at least two, but as a rule far more participants, which are preferably arranged hierarchically, with one participant embodied as the central participant and the other participants as secondary participants of the communication system. This kind of hierarchical arrangement structure is known for instance as a master-slave structure, where the central participant is a “master” or master participant, and the secondary participants are “slaves” or slave participants. Typically, the central participant generates control signals, which are sent to the secondary participants via communication lines. Conversely, however, the secondary participants can also generate signals and send them to other secondary participants or to the central participant.

Often, such a communication system is arranged in a ring structure. A signal generated by the central participant is fed the central participant into a communication line connecting the participants, and then it travels through the ring structure, passing through the secondary participants in serial order.

Currently, one such communication system of ringlike structure is available from the present Applicant on the market, under the tradename SERCOS interface®, which generates control signals and sends them to secondary participants via a central participant. The secondary participants are typically connected to the central participant by means of optical waveguides. Preferably, this communication system is employed for regulating and controlling distributed motors, such as synchronous or asynchronous motors. The secondary participants of the communication system can then be embodied for instance as regulating devices for regulating and controlling one motor each, or may be integrated into these regulating devices. This communication system is widely used, especially in machine tools, printing presses, knitting machines, and machines in the general field of automation. At preferably equidistant time increments, the central participant generates a synchronization telegram or synchronization signal and feeds it into the communication ring. Upon reception of the synchronization telegram or synchronization signal, set-point/actual-value processing is coupled into the regulating devices, typically via a time parameter, and this leads to a determination and output of control and regulating parameters to the various control motors.

However, because of the serial mode of transmission of communication information from one participant to the next, this system, which is available on the market, has the disadvantage that if a route error occurs, for instance the failure of one participant, or the failure of the communication connection between two participants, then all the following participants in the system receive no further communication information.

To increase the error tolerance here, the use of a double-ring topology is proposed in the dissertation entitled “Fehlertolerantes Kommunikationssystem für hochdynamische Antriebsregelungen”[“Error-tolerant communication system for highly dynamic drive regulating means”] by Stephan Schultze, Darmstadt, 1995.

As shown in FIG. 2, the double-ring topology includes two contrarily operating communication rings 110, 120, which each begin and also end at the central participant 130. In each of the two communication rings 110, 120, beginning at the central participant 130, the same and hence redundant communication information is sent to the secondary participants 100′, 100″, 100″′, 100″″. The information signals travel through the ring topology, in each case along the communication paths shown in FIG. 2. The feedforwarding of the central participant to the two rings is done independently of one another via one transmission unit 131′, 131″ and one reception unit 132′, 132″, respectively, per communication ring. Thus there is no direct coupling of the communication rings in the central participant. The secondary participants 100′, 100″, 100″′, 100″″, conversely, as FIG. 1 shows especially well, each have two coupling connections 113′, 123′; 113″, 123″, 113″′, 123″′; 113″″, 123″″, in the form of “short-circuit loops” between the communication paths 110 and 120. The short-circuit loops are each connected directly to one communication line at the first end, in a signal input region of the secondary participant of the respective communication path, and are each connected on the second end to a second input of a multiplexer (MUX) 112′, 122′; 112″, 122″; 112″′, 122″′; 112″″, 122″″. The communication line of the respective communication path is connected to the respective first input of the multiplexer. In an initial configuration of the communication system, the respective communication path is switched through via the multiplexer. Downstream of each multiplexer is a processing unit, in this case an HDLC unit 111′, 121′; 111″, 121″; 111″′, 121″′; 111″″, 121″″(HDLC=High Level Data Link Control, i.e., protocol agreement for data transmission), which is subjected to the respective signal that has been switched through by the multiplexer. If now, between two secondary participants—in FIG. 3, between the secondary participants 100″and 100″′—a route error 150, for instance shown as in FIG. 3, occurs in the form of an interruption in the communication line of a communication path—in FIG. 3, the communication path 110—then the input of the multiplexer, located in the affected communication path, of the participant downstream in the signal travel direction of the route error—in this case, the multiplexer 112″′ of the secondary participant 100″′—can be switched over, so that the signal present at the short-circuit loop from the other communication ring 120 is fed forward to the portion of the communication ring 110, downstream of the multiplexer, that is affected by the route error. Thus in the event that a route error occurs, the communication system can be reconfigured in a simple way, and a permanent failure of a major portion of the communication system, or even a total failure of the communication system, can be averted.

However, it has been found that the version proposed in the dissertation by Stephan Schultze can be employed to only a limited extent for use in highly dynamic communication systems. Particularly at very high transmission rates of the communication system, the switchover and signal monitoring of the signals of the two rings by means of a hardware circuit provided for that specific purpose is problematic. In particular, this can for instance lead to the redundant transmission of the signal from one communication ring to the other communication ring not being done with sufficiently high dynamics to meet the requirements of highly dynamic control systems.

### SUMMARY OF THE INVENTION

It is accordingly the object of the invention to make a participant of a communication system available in which redundant signal transmission is effected, to protect against a route error. The participant here is intended to have an improved dynamic operating performance, in comparison to the prior art, particularly in the event that a route error occurs. It is also an object of the invention to make a communication system with an improved dynamic performance available.

These objects are attained according to the invention by the participant as defined by claim 1 and the communication system as defined by claim 15. Further advantageous features of the invention are found in the dependent claims.

The participant of the invention, which can be used as a participant in a communication system, includes at least one first and one second communication path. In the communication system, for this purpose, the communication paths are preferably arranged in a double-ring topology, which expediently operates in contrary directions. The first communication path in the participant is assigned a first processing unit for processing the information signals, obtained via the first communication path, and/or for generating and sending information signals via the first communication path. The second communication path in the participant is assigned a second processing unit, for processing the information signals obtained via the second communication path, and/or for generating and sending information signals via the second communication path. The processing units are advantageously each inserted into the respective communication paths. To override a route error that has occurred in the second communication path of the communication system, a first activatable coupling is also located in the participant between the first communication path and the second communication path, in such a way that when the coupling is activated, information signals are transmitted from the first communication path to the second communication path, and to that end, the information signals are picked up from the first communication path and delivered to the second communication path, which is the one affected by the route error. The delivery to the first activatable coupling is effected in the participant downstream in the signal travel direction of the processing unit of the second communication path. According to the invention, the processing unit checks the input signal for its presence, and a phase locked loop is provided in the participant for phase preparation of the information signal received.

Expediently, furthermore, the pickup of the first activatable coupling is located in the participant downstream in the signal travel direction of the processing unit of the first communication path.

A participant embodied according to the invention in this way can be employed as a central participant or a secondary participant in an either centrally or noncentrally controlled communication system, for instance for regulating and controlling a drive unit or a plurality of drive units. As also known from the dissertation entitled “Fehlertolerantes Kommunikationssystem für hochdynamische Antriebsregelungen”[“Error-tolerant communication system for highly dynamic drive regulating means”] by Stephan Schultze, Darmstadt, 1995, known from the prior art, the communication path, which within the scope of the invention is double in at least one portion, serves to improve the error tolerance. Especially preferably, the communication system is embodied for this purpose with a closed double-ring topology. Via each of the communication paths, the same control instruction or the same information signal is sent to the participant from the central participant or a secondary participant, so that the signal information reaches the respective participant twice and hence redundantly, in an initial configuration of the communication system.

The processing of the signal arriving at the participant via a communication path is done in the processing unit assigned to that particular communication path. In order to check the information signals, arriving separately and independently from one another via the two communication paths, for correctness and completeness, a comparative calibration of the two signals that have been input is done by the processing units, before the signal information that has arrived is sent onward, for instance in the form of a control signal, to a drive regulating device. In addition to the signal verification attained via the calibration of the two signals, a communication system with a doubly embodied communication line and communication in contrary operation also has the particular advantage that even if the communication over one of the two, or over both, communication lines is impeded, the control and information signals still arrive at the participant via the second communication line. An expediently contrarily operating communication system embodied with double-ring topology thus has increased error tolerance, compared to a single-ring topology.

To increase the error tolerance, naturally more than two communication paths may be located parallel to one another in at least one portion of the communication system. Although providing three or more communication paths can increase the redundance of the signal transmission and further reduce the vulnerability to route error, the costs for such a communication system do increase disproportionately, compared to the improvements achieved. Although the invention is described below only in terms of communication systems with communication paths embodied in double form in at least one portion, nevertheless the invention is no way limited to such communication systems; a greater number of communication paths may also be provided in at least one portion of the communication system. The wording selected in the claims thus also encompasses such systems having a greater number of communication paths in at least one portion.

In the event that a route error occurs in a second communication path of the participant embodied according to the invention—such as the failure of a component of a further participant, which is integrated into the second communication path and is located upstream of the participant in question in terms of the signal travel direction in the second communication path, or in the event of an interruption in the signal line leading to the participant in question—then, in order to redeliver the information signal to that part of the communication path which is downstream in the signal travel direction of the place where the route error occurred and thus as it were to cancel the route error, the information signal can be picked up from the first communication path by way of activation of the first activatable coupling and can be transmitted to the second communication path. The second communication path of the participant, if a route error occurs, can thus be reconfigured during operation of the participant in a communication system, by activation of the first activatable coupling.

The delivery to the first activatable coupling for introducing the information signal into the second communication path is located, according to the invention, in the participant downstream in the signal travel direction of the processing unit of the second communication path. Preferably, the pickup of the first activatable coupling is also located in the participant downstream in the signal travel direction of the processing unit of the first communication path.

In comparison to the version known from the dissertation by Stephan Schultze, it has been found that the participant embodied as described according to the invention has a markedly improved dynamic performance. The information signal, delivered to the participant embodied according to the invention via the first communication path and coupled into the participant, is delivered directly to the first processing unit of the participant and signal-processed in it, after the coupling in of the signal, regardless of whether a route error has occurred in the second communication path or not. If a route error now occurs in the second communication path, upstream of the participant in the signal travel direction of the second communication path, then as a result of the disposition according to the invention of the delivery point to the first activatable coupling downstream in the signal travel direction of the second processing unit of the participant, no information signal is still delivered to the second processing unit even after the reconfiguration of the communication paths. Typically, the input signal is checked in the processing unit for signal quality and presence. Missing signals can thus be detected by the processing unit. In comparison to the version known from the dissertation by Stephan Schultze, it has been found that this signal checking (upstream of the multiplexer) must be performed with a special logic, which increases the complexity and expense.

If an optimized processing unit is used, this special logic can be embodied more simply than in the case of a logic constructed specifically for the purpose within programmable logic modules.

Since here thus only the first processing unit receives an information signal sent to it, a calibration of the information signals arriving in both processing units of a participant, as is expediently usual in operation without route errors, is thus dispensed with. An information signal arriving in the first processing unit can thus be converted directly into a control signal, without first having to wait for the arrival of the information signal in the other processing unit to perform a calibration of the received signals. Thus even in the event of reconfiguration, no worsening of the dynamic performance of the participant occurs. In the version known from the dissertation by Stephan Schultze, conversely, both the signal carried in the first communication path and the picked-up signal, delivered to the second communication path, after being coupled into the participant, first each reach a respective multiplexer before reaching the respective processing unit. Hence both as it passes through the multiplexer and because of the calibration done after the processing, the signal is varied in each case, which is associated with worsening of the signal.

Also in the version according to the invention, the pickup of the first activatable coupling is advantageously located in the participant downstream in the signal travel direction of the processing unit of the first communication path. As a result of this as well, on the one hand the dynamic performance is improved, since the passage through a signal shunt, for instance, serving as a pickup occurs only downstream of the processing unit. On the other hand, because the pickup is located downstream of the processing unit, the possibility that the information signal might be adulterated before processing by possible feedback via the first activatable coupling is furthermore avoided. Expediently, the first activatable coupling includes a first intermediate connecting line, for connecting the first communication path to the second communication path, and a first switchover element, inserted into both the first intermediate connecting line and the second communication path.

While the information signal is transported between the participants typically as an optical light signal by means of optical waveguides, upon entering the participant it is converted into an electrical signal and is transported and processed as an electrical signal within the participant. In this sense, the intermediate connecting line can advantageously be embodied as a simple electrical conductor track for conducting electric current. The first switchover element is preferably embodied as a multiplexer with two inputs and one output, and the inputs are switchable selectively to the output. Thus by switchover of the multiplexer, the input can be switched over to the intermediate connecting line, so that via the intermediate connecting line, current is carried from the first communication path to the second communication path.

In a preferred embodiment of the invention, besides the first activatable coupling, a further, second activatable coupling is located in the participant between the communication paths, such that upon activation of the first coupling, information signals are transmitted from the one, first communication path to the other, second communication path, and upon activation of the second coupling, information signals are transmitted from the second communication path to the first communication path. The second activatable coupling is also located for this purpose downstream in the signal conduction direction of the processing unit of the second communication path. The structure, functioning and mode of operation of the second activatable coupling correspond to those of the first activatable coupling. While the first activatable coupling is activated if a route error occurs in the second communication path, the second activatable coupling is activated if a route error occurs in the first communication path. Thus both communication paths of the participant are secured against the occurrence of a route error. Each information signal arriving in the participant, after being coupled in, first travels through the respective processing unit assigned to that communication path and is processed there, before it travels, after processing, through the pickup point of the one activatable coupling and the introduction point of the other activatable couplings. In comparison to the version known from the dissertation by Stephan Schultze, the participant according to the invention, because of the location of each of the activatable couplings behind the respective processing units, has a markedly improved dynamic performance both in the initial configuration of the communication system and in the event of reconfiguration of the communication system.

The participant of the invention may be located as a secondary participant in a central or noncentral communication system. Preferably, all the secondary participants of one communication system are embodied according to the invention, so that as a result, the entire communication system is protected against route errors.

In an especially advantageous version, however, the central participant of a master-slave communication system is also embodied according to the invention, so that the central participant as well is protected against possible route errors.

If checking for the presence of an input signal in the participant is implemented such that the input signal of a participant is checked by means of an edge detection in the participant, then quite inexpensive, simple implementation is possible, for instance by means of counters. For instance, two independent counters or edge detections are present in one participant. They are incremented by the incrementation rate of reception and are reset by an arriving signal edge. In error-free operation, the spacing between two successive edges is then equivalent to a fixed counter state. If the counter state is higher, it can be assumed that a route error exists. This is approximately equivalent to the typical mode of operation of a watchdog timer.

It is advantageous if the participants are capable, within the scope of the aforementioned checking for the presence of a signal, of generating a zero-bit current for subsequent participants. This can be utilized so that only the participant physically following the error becomes active, while the participants following it, in which of course the input signal is also missing, do not likewise activate their switchover mechanisms and hence misinterpret an error, not directly present at their input, as an error. It is also suitable not to send the zero-bit current until beyond a defined counter state, so as not to incorrectly handle a temporary missing signal as a critical error. In the embodiment according to the invention, for example, the zero-bit current is not fed forward until beyond a counter state of 16 bit times. This means that no edge was present at the input for a length of 16 bit times. Technically, because of its successive edge change (NRZI coding), the zero-bit current causes a resetting of the counters of all the downstream participants, so that their shutoff in advance does not become active (see also the preceding paragraph). An error is then handed over to higher protocol layers for initiating a correction, such as a reconfiguration.

In a further aspect, the invention provides a communication system for directed communication between participants of the communication system, in which the communication system of the invention includes a central participant and at least one secondary participant, and preferably many secondary participants. This also encompasses communication systems of the kind in which the task of the central participant is intermittently taken over by secondary participants. At least one of the participants, and preferably all the secondary participants and especially preferably all the participants of the communication system, are embodied as described above with an activatable coupling, preferably each with a number of activatable couplings corresponding to the number of communication paths. Such a communication system can be used for controlling highly dynamic drive regulations, and in addition, high error tolerance to route errors occurring during operation is provided. In comparison to communication systems known from the prior art, the communication system of the invention has improved dynamics. Also, the central participant can be protected according to the invention against route errors that occur.

The communication system is expediently embodied with double-ring topology, each with annularly closed communication paths. Because of the closure of the respective communication path, a directed communication along the communication path is possible, yet each participant is still capable of communicating with every other participant.

In addition, an information signal sent by one participant can travel all the way through the ring topology, until it reaches the same participant again that sent the signal. The sending participant can thus check, when the signal arrives again, whether the signal has passed through all the further participants.

Expediently, the communication system of the invention is embodied as a decentralized control system, with a master-slave structure, with the central participant as a master and the secondary participants as slaves. Because of the very good dynamic properties and the error tolerance, the communication system of the invention is especially well suited for controlling and regulating many drives that operate synchronously with one another.

### BRIEF DESCRIPTION OF THE DRAWINGS

The invention is described in further detail below in terms of exemplary embodiments in conjunction with the drawings. Shown are:

FIG. 1, a basic circuit diagram of a participant, known from the prior art, of a communication system;

FIG. 2, the topology of a communication system known from the prior art;

FIG. 3, the communication system of FIG. 2, upon reconfiguration in response to a route error;

FIG. 4, a basic circuit diagram showing the construction of the participant, embodied according to the invention, of a communication system;

FIG. 5, the topology of a communication system embodied according to the invention;

FIG. 6, a first reconfiguration circuit of the communication system of the invention shown in FIG. 5, where a double route error has occurred among the secondary participants;

FIG. 7, a further reconfiguration circuit of the communication system of the invention shown in FIG. 5, where a single route error has occurred among the secondary participants;

FIG. 8, a further reconfiguration circuit of the communication system of the invention shown in FIG. 5, where a double route error has occurred between the central participant and a secondary participant;

FIG. 9, a further reconfiguration circuit of the communication system of the invention shown in FIG. 5, where a single route error at the output of the central participant has occurred between the central participant and a secondary participant;

FIG. 10, a further reconfiguration circuit of the communication system of the invention shown in FIG. 5, where a single route error at the input of the central participant has occurred between the central participant and a secondary participant.

In the drawings, only those elements and components that are essential to comprehension of the invention are shown schematically.

Components that are identical or function identically are largely identified by the same reference numerals throughout the drawings.

### WAYS OF EMBODYING THE INVENTION

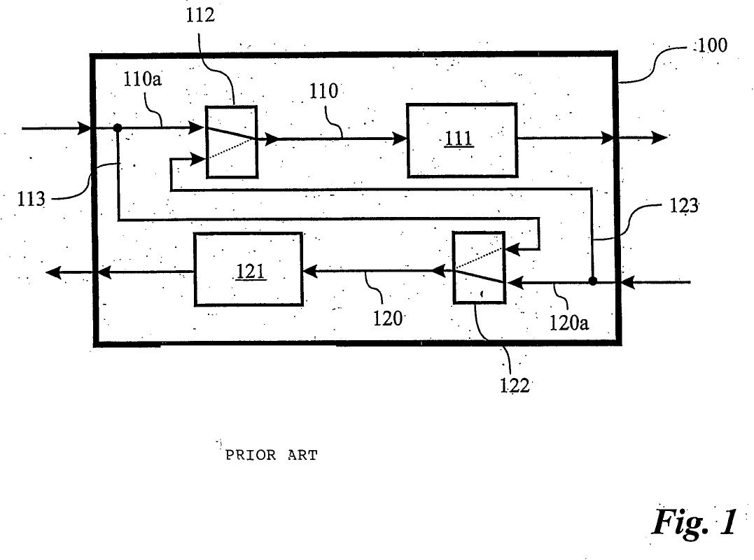

In FIG. 1, in a basic circuit diagram, the slave participant 100, which has already been referred to at the outset, known from the dissertation entitled “Fehlertolerantes Kommunikationssystem für hochdynamische Antriebsregelungen”[“Error-tolerant communication system for highly dynamic drive regulating means”] by Stephan Schultze, Darmstadt, 1995, is shown. For increasing the error tolerance, two contrary communication paths 110, 120 are implemented in the participant 100. The slave participant further includes two signal and data processing units 111, 121, operating separately from one another, for signal processing; the first processing unit 111 is inserted into the first communication path 110, and the second processing unit 121 is inserted into the second communication path 120. An information signal entering via the first communication path 110 is processed in the first processing unit 111, while an information signal entering via the second communication path 120 is processed in the second processing unit 121. FIG. 1 does not show that the processing units calibrate the entering information signals against one another, so that by means of the doubled communication paths and the doubled signal processing, redundance of the entering information signal for the slave participant 100 is provided.

Two coupling connections 113, 123 in the form of “short-circuit loops” are also located in the slave participant 100, between the communication paths 110, 120. The short-circuit loops 113, 123 each branch off from the respective communication path 110 or 120 upstream in the signal travel direction of the respective processing unit 111, 121 and connected on the other end to a second input of a multiplexer (MUX) 122, 112 integrated into the respective other communication path 120 or 110. The communication line 110a, 120a of the respective communication path 110, 120 is connected to the first input of the respective multiplexer 112, 122.

In an initial configuration of the slave participant, the communication paths 110, 120 of the applicable communication rings are switched through via the multiplexers 112, 122. However, if a route error occurs in a communication system, for instance between a participant located upstream in the signal travel direction in a communication system and the participant in question, so that no further signal enters an input of the participant, then the input of the multiplexer that is downstream of the route error in the signal travel direction can be switched over, so that the signal from the other communication path, present at the short-circuit loop, is fed forward to the processing unit downstream of the multiplexer. Thus in the event that a route error occurs, the communication system can be reconfigured in a simple way, so that a permanent failure of major portions of the communication system or even the total failure of the communication system will not occur.

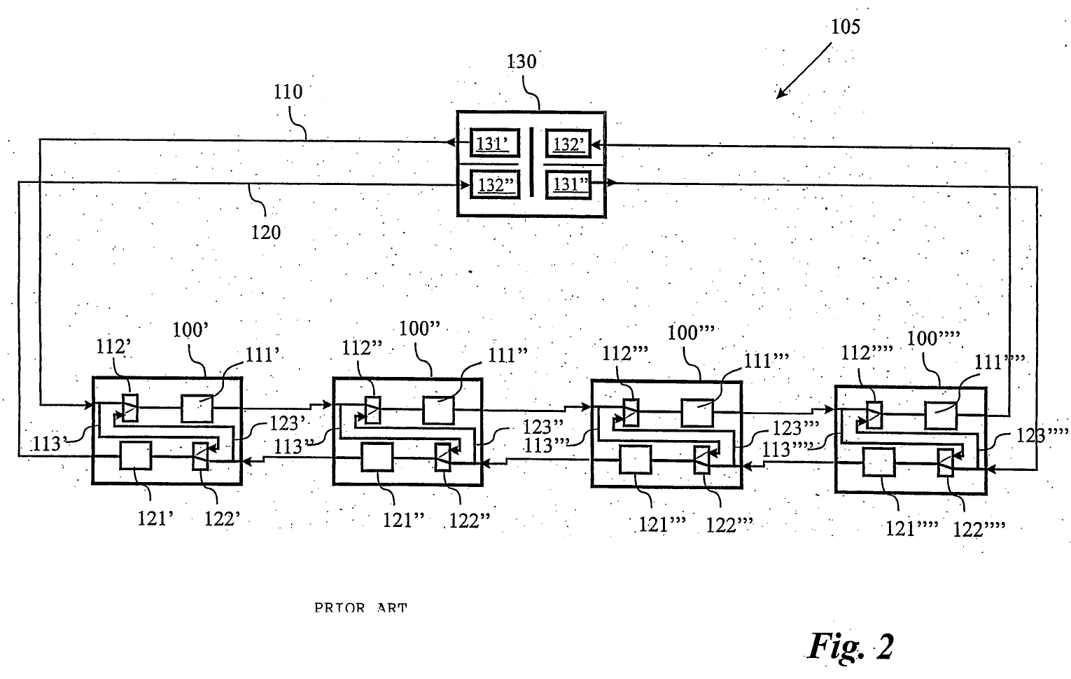

In FIG. 2, the topology of a communication system 105, also described in the dissertation entitled “Fehlertolerantes Kommunikationssystem für hochdynamische Antriebsregelungen”[“Error-tolerant communication system for highly dynamic drive regulating means”] by Stephan Schultze, is shown. The communication system 105 is embodied with a double-ring topology, as a master-slave communication system with a “master” 130 as the central participant and with many secondary participants or so-called “slaves” 100′, 100″, 100″′, and 100″″. The slaves are each embodied like the participant shown in FIG. 1. Directed communication takes place between the master and the slaves via each of the two rings 110, 120 of the double-ring topology. The master is both the starting and ending point of a communication signal here. Beginning at the master, a first control signal generated by the master travels through the ring 110 counterclockwise, while conversely, chronologically synchronously with the first control signal, a second control signal travels clockwise through the ring 120. On reaching a slave, the transmitted control signal is first coupled into the respective slave and then processed in the assigned processing unit 111′, 121′; 111″, 121″; 111″′, 121″′ and 111″″, 121″″. After processing, the processed control signal is carried in the slaves 100′, 100″, 100″′, and 100″″ to a respective decoupling unit and from there, via an intermediate connecting line of the communication path, it reaches the next participant in the signal travel direction.

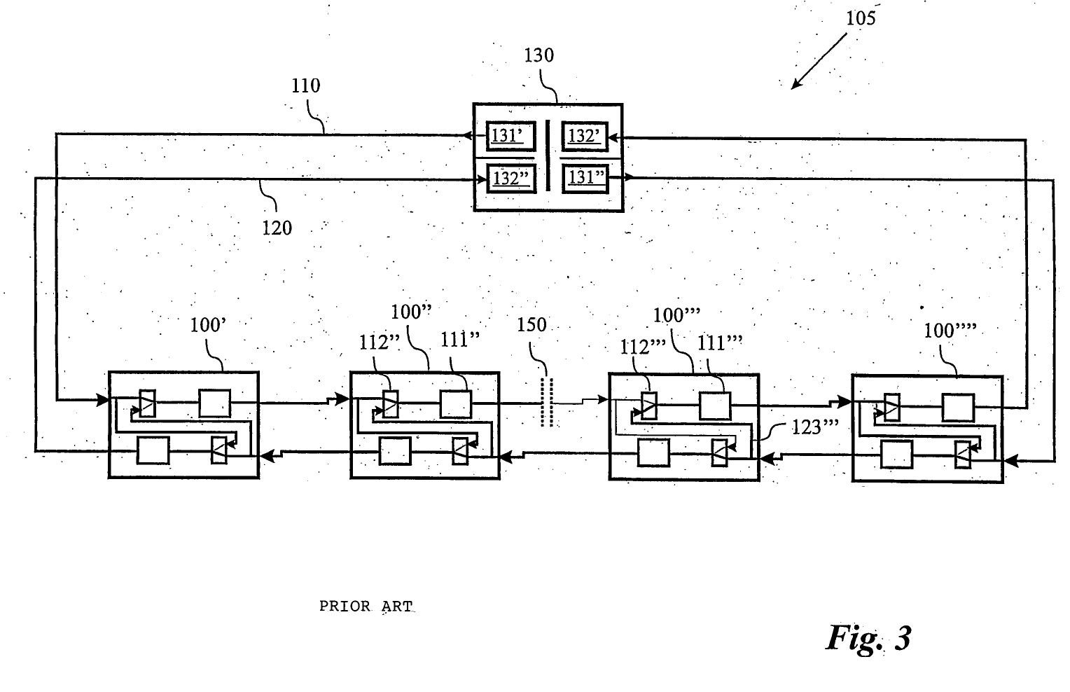

However, if a route error occurs, as is the case for instance in FIG. 3 in the form of a single route error 150 from an interruption in the communication line between the slave 100″ and the slave 100″′ in the ring 110, then the communication system has the capability of performing a reconfiguration of the communication paths 110 and 120, so that a failure of the entire communication system does not occur. For that purpose, only the short-circuit loop that discharges into the particular multiplexer that is downstream from the route error in the signal travel direction is fed forward via the multiplexer. As a result, a transfer takes place of the signal carried in the respective other ring, which is redundant to the signal that is carried in the ring affected by the route error. In FIG. 3, one such reconfiguration state after the occurrence of the route error 150 is shown. The multiplexer 112″, inserted into the first ring 110, of the slave 100″ is switched over to the short-circuit loop input, so that as a result, the information signals of the processing unit 111″′ of the slave 100″′ traveling through the ring 120 are inserted into the ring 110.

Whichever signal path is active is indicated in FIG. 3, as in the subsequent drawings, with a heavy solid line, while the signal path that is inactive is identified by a thinner line.

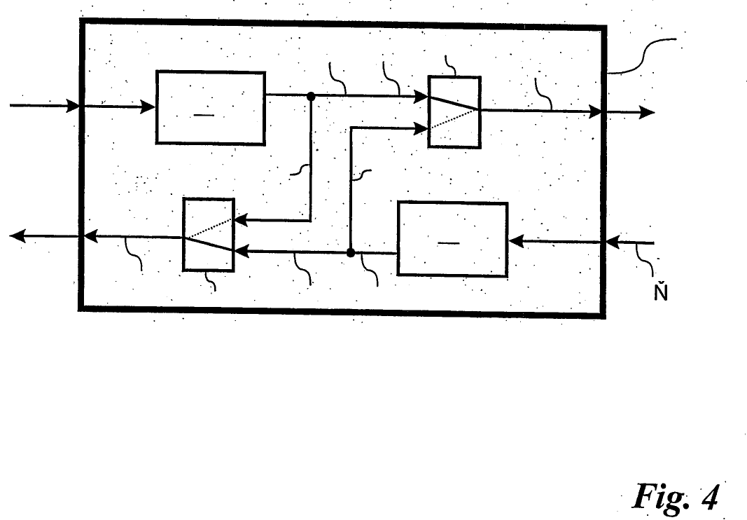

In FIG. 4, in a basic circuit diagram, the construction of a participant 1, embodied according to the invention, of a communication system is shown, which in use in a communication system has improved dynamic properties and hence improved real-time capability, compared to the participants known from the prior art.

In participant 1 shown here, two contrary communication paths 10, 20 located parallel to one another are provided. In the first communication path 10, the upper one in FIG. 4, an information signal is transported from left to right, while in the second communication path 20, which is the lower one in FIG. 4, an information signal transported from right to left. The participant 1 shown in FIG. 4 is thus suited for use in a communication system with double-ring topology and with directed, contrary communication.

One processing unit 11 and 21, respectively, for processing arriving information signals, is inserted into each of the two communication paths 10, 20. The processing units 11 and 21 are each embodied here as microprocessor systems for communication protocol processing, preferably for HDLC processing (HDLC=High Level Data Link Protocol). In the example shown here, an ASIC under the name SERCON 816 made by ST Microelectronics is used as the processing unit.

A multiplexer 12 and 22 is also downstream in the signal travel direction of the respective processing units 11, 21 in the participant 1 of the invention and is inserted into the respective communication path 10, 20. Each of the multiplexers 12, 22 has two inputs and one output; the inputs can be switched selectively through to the output. A first input of each of the multiplexers 12, 22 is connected via a respective intermediate connecting line 10a, 20a of the respective communication path 10, 20 directly to the output of the respective upstream processing unit 11, 21. The output of each of the multiplexers 12, 22 is connected to a respective connecting line 10b, 20b, leading onward, of the applicable communication path 10, 20.

In the initial configuration of the participant 1, the first inputs of each of the multiplexers are switched through to the outputs of the multiplexers, in order to furnish a continuous signal transit path along the respective communication path 10 and 20.

To enable reconfiguring the signal transit path, if a route error occurs, in such a way that the information signal that is carried in the other communication path from the communication path affected by the route error will be diverted from the communication path affected by the route error, the second input of each of the multiplexers 12, 22 is connected to a respective further intermediate connecting line 23, 13. The intermediate connecting lines 13, 23 are connected in turn, each by its other end, to the respective other communication path, so that the information signal carried in the respective other communication path is delivered, via the respective intermediate connecting line 13 or 23, to the second input of each multiplexer. The connecting points where the intermediate connecting lines are connected to the communication paths are located between the processing units 11 and 21 of the communication paths 10 and 20, respectively, and the multiplexers 12 and 22, respectively, inserted into the communication paths.

Thus if a route error occurs in one of the communication paths 10 or 20 upstream in the signal travel direction of the participant 1 of the invention, or within the participant 1 in a region up to respective processing unit 11, 21—for instance from an interruption in the line or a failure of a component inserted into the line—then after a detection phase, whichever multiplexer 12 or 22 is downstream of the route error in the communication path 10 or 20 affected by the route error switches over to the second input. This assures that the portion of the communication path downstream of the multiplexer is again subjected to the information signal diverted from the other communication path, and hence downstream participants can continue to operate properly. A route error occurring in one communication path thus typically leads to an impairment in the operation of only the processing unit directly downstream of the route error in the affected communication path.

In comparison to the version known from the dissertation by Stephan Schultze and shown in FIG. 1, the participant of FIG. 4 has improved dynamic properties. For instance, if a route error occurs in the lower communication path 20, in terms of FIG. 4, upstream of the participant 1 in the communication line 20d, then the lower processing unit 21 of the lower communication path 20 no longer receives any information signal. However, the information signal continues as before to reach the participant 1 via the intact, upper communication path 10 and is signal-processed in the upper processing unit 11 there immediately after arriving in the participant. In this case, however, a calibration of the signals received and processed in the processing units 11 and 21 before any control signals, generated in the processing units on the basis of the information signal received, are sent to one or more control units (such as one or more control units for controlling electric motors) is dispensed with necessarily in this case, and hence even if a route error occurs, the dynamics of the participant 1 are not impaired.

The information signal of the upper communication path 10 also travels through the multiplexer 12 only after processing in the processing unit 11, so that delays that are caused by the signal transit through the multiplexer 12 cause no delay in the processing of the information signal in the participant 1. Because of the embodiment of the participant of the communication system and the embodiment of the participant in accordance with the invention, the stability of the communication system and the sturdiness of its redundance are enhanced. A communication system embodied in this way can also be used for transmission rates higher than 4 Mbit/s and 16 Mbit/s with adequate stability of the communication system.

Typically, the information signal is carried between the participants via optical waveguides. To that end, the information signal is prepared by a transmission unit as an optical light signal and fed into the optical waveguide. Within the applicable participant, however, it is expedient for the information signal to be forwarded and processed as an electrical signal. To convert the information signal from an optical signal into an electrical signal, a receiver, preferably an optical receiver, for receiving and coupling in the arriving information signals from the communication path into the participant is expediently located in the participant, in the input region of each communication path. These receivers are not shown in FIG. 4.

Moreover, a decoupling unit, preferably a light-emitting diode with trigger circuit, is expediently located in each communication path of the participant of the invention, where the communication path exits the participant, for decoupling the information signals from the participant into the communication path; this decoupling unit is also not shown in FIG. 4.

Also not shown in FIG. 4 is the fact that a phase locked loop for phase preparation of the received information signal is additionally expediently located in each communication path of the participant, typically in the respective processing unit. The phase locked loop, preferably embodied as a DPLL, carries out a signal edge regeneration, by means of overscanning of the electrical information signal.

In the circuit discussed in the dissertation by Stephan Schultze, the reception signal travels through the multiplexer first before being regenerated or processed in the processing unit. The signal traveling through the multiplexer is worsened as a result. This is critical, because the signal converted back into an electrical signal has the “worst” quality at that point, and the signal processing by the processing unit is made more difficult because of this further worsening.

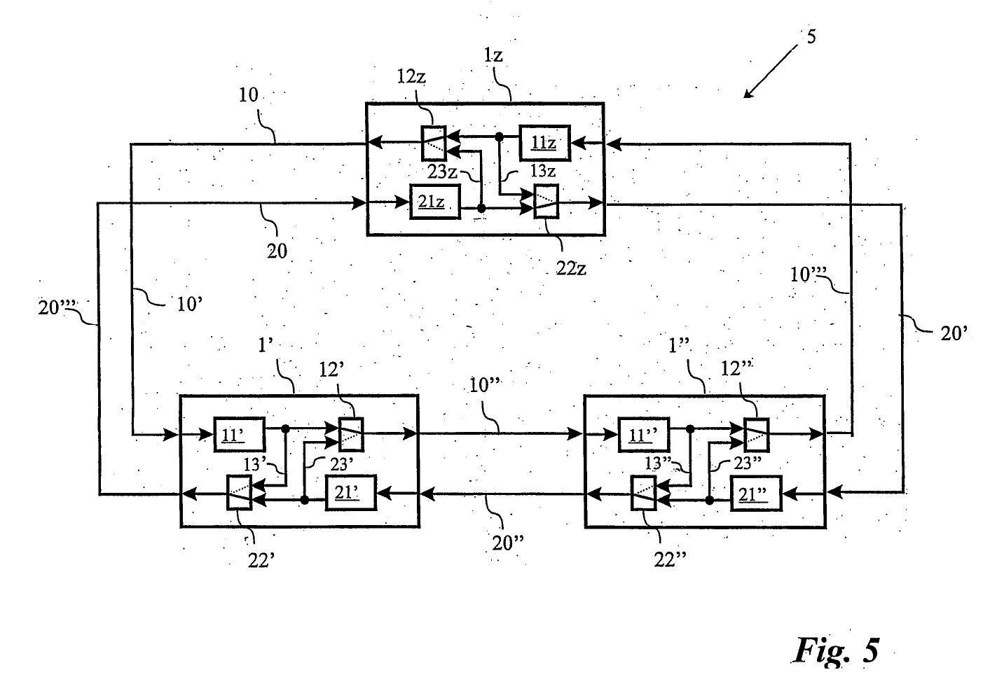

In FIG. 5, the topology of a communication system 5 embodied according to the invention is shown. The communication system 5 shown here includes a central participant 1z and two secondary participants 1′, 1″. The construction of all three participants is equivalent to a construction of the participant 1 shown in FIG. 4 and embodied according to the invention. It is hence also possible to transfer the function of the central participant to one of the secondary participants, and vice versa.

The communication system 5 is embodied with a double-ring topology; that is, two communication paths 10 and 20 are provided, which each begin and end at the central participant 1z and thus each form a closed ring. The communication within a ring takes place in directed fashion, and the direction of communication of the two rings is contrary to one another.

As the connecting lines 10′, 10″, 10″′and 20′, 20″, 20″′ between the participants, optical waveguides are provided here, which enable transmission of a signal at a high transmission speed with very high signal fidelity.

The participants lz, 1′, 1″shown in FIG. 5 are all located in the respective initial configuration; that is, all the multiplexers 12z, 22z; 12′, 22′, and 12″, 22″ are each connected such that the communication paths 10, 20 are switched through, and ring communication along the closed rings 10 and 20 is possible in each case.

However, if a route error, then the multiplexers downstream of the route error in the signal travel direction can each be switched over for reconfiguring the topology.

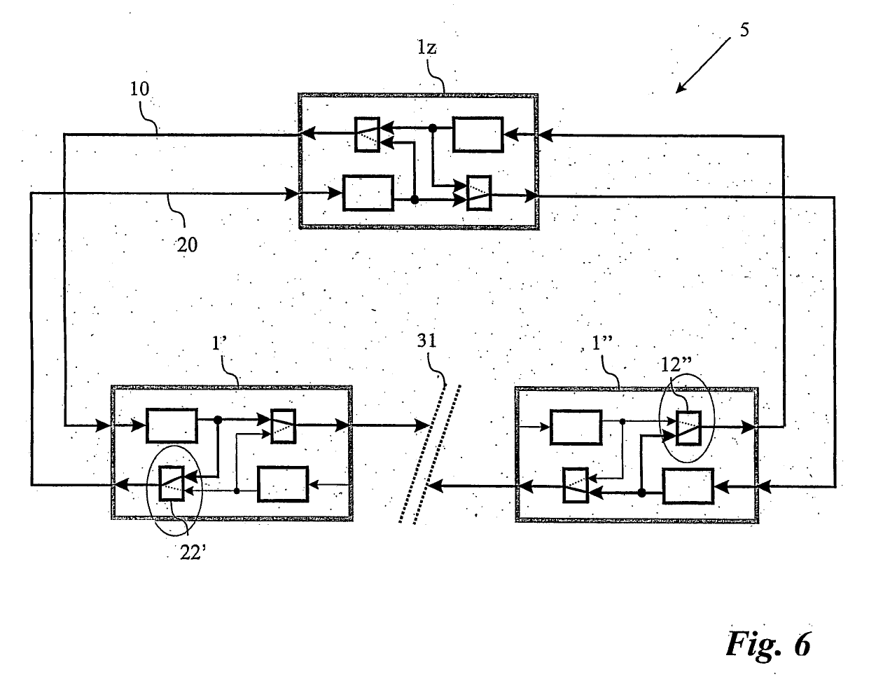

In FIG. 6, one such reconfiguration circuit of the communication system 5, embodied according to the invention, of FIG. 5 is shown when a double route error 31 has occurred between the secondary participants 1′ and 1″. The connecting lines of the two communication paths 10″, 20″ between the secondary participants have been severed here because of a malfunction. Thus no information signal from the one secondary participant can reach the other secondary participant directly. The multiplexers 22′ and 12″, each downstream of the route error 31 in the signal travel direction, are switched over, after a detection phase for detecting the route error, so that the information signal from the respective other communication path is fed, via the respective multiplexer 22′ and 12″, into the communication path affected by the route error, in each case downstream of the route error 31 in the signal travel direction. In FIG. 6, the switched-over multiplexers are each identified by a circle. The signal paths that are effected are each represented by a thicker line, while the inoperative paths are represented by a thinner line.

In the detection phase for detecting the route error, there is first a wait, lasting at least one clock rate of the information signal, for the arrival of an information signal, before the multiplexer is switched over. Suitable detection methods are known from the prior art.

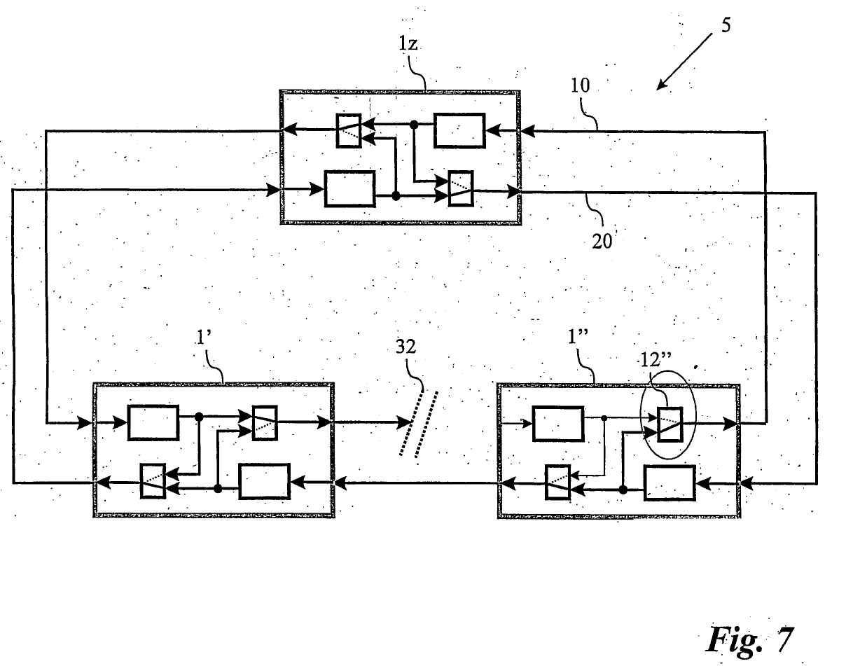

In FIG. 7, a further reconfiguration circuit of the communication system according to the invention shown in FIG. 5 is shown, for a single route error 32 occurring between the secondary participants.

In reaction to the route error, here only the upper multiplexer 12″, marked by a circle, of the second participant 1″ is switched over in such a way that the information signal from the other communication ring 20 is fed into the communication path 10 downstream of the route error 32 in the signal travel direction.

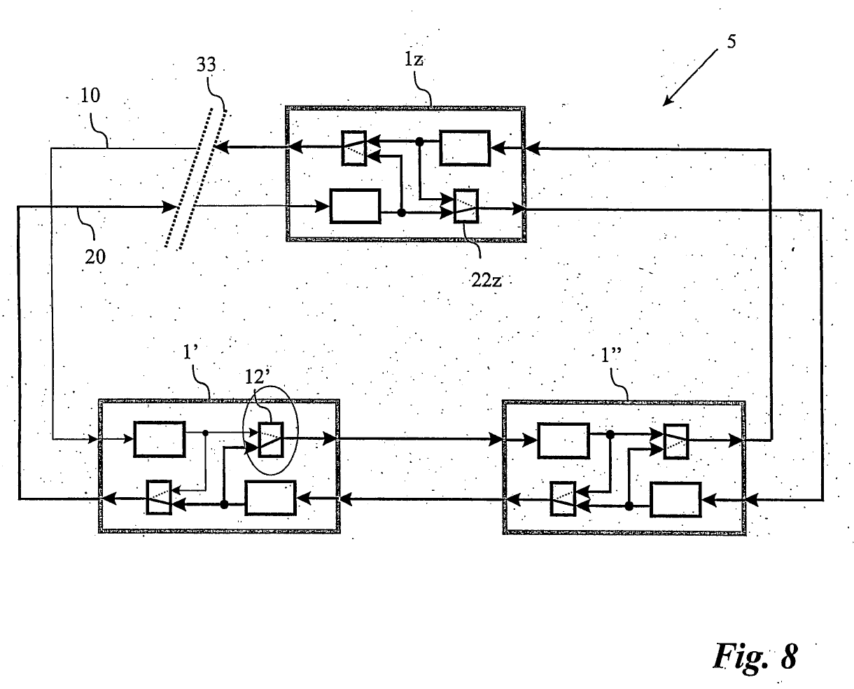

In FIG. 8, a further reconfiguration circuit of the communication system according to the invention shown in FIG. 5 is shown, for a double route error 33 occurring between the central participant lz and the first secondary participant 1′. Here, only the first multiplexer 12′ of the first secondary participant 1′ is switched over. Since the information signal is not carried onward beyond the central participant 1z here, a switchover of the multiplexer 22z, downstream of the route error in the signal travel direction, of the lower communication ring 20 in the central participant 1z and is not necessary. It is true that the central participant here, in the lower communication ring, does record the non-reappearance of the originally sent information signal. However, this does not impair the function of the communication system.

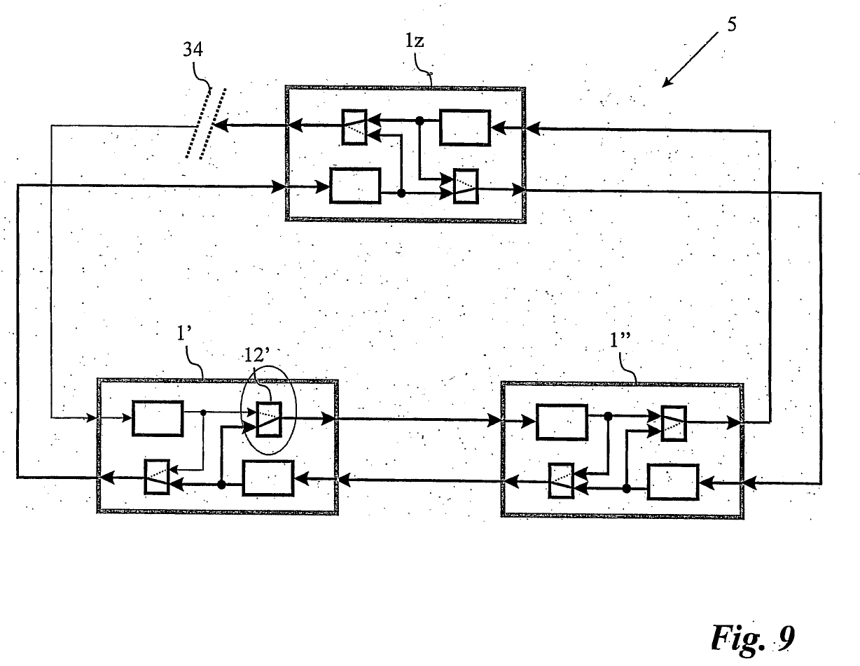

In FIG. 9, a further reconfiguration circuit of the communication system according to the invention shown in FIG. 5 is shown, for a single route error 34 at the output of the central participant occurring between the central participant 1z and the first secondary participant 1′. In the same way as in FIG. 8, the upper multiplexer 12′ of the first secondary participant is switched over here.

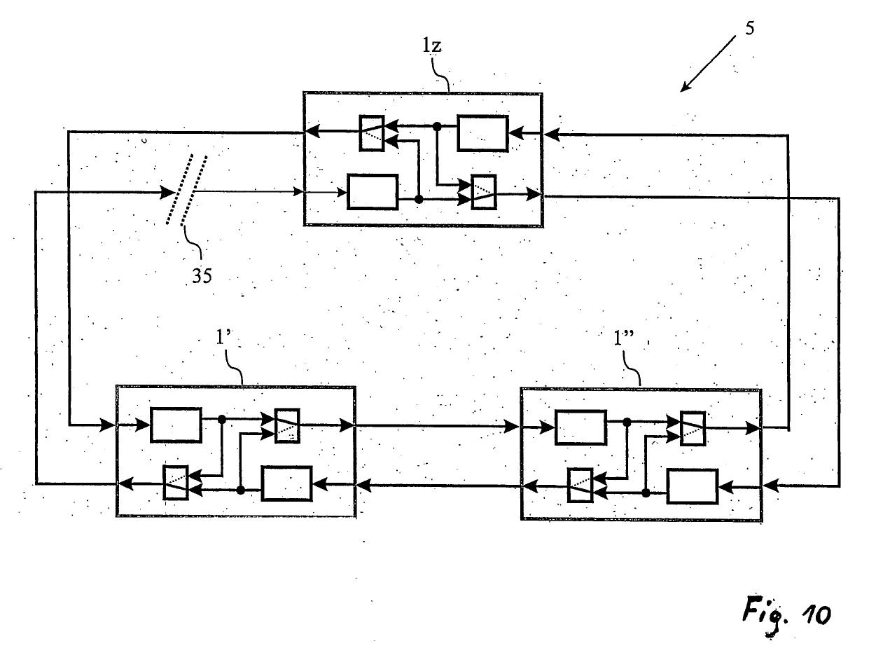

In FIG. 10, a further reconfiguration circuit of the communication system according to the invention shown in FIG. 5 is shown, for a single route error 35 at the input of the central participant occurring between the first secondary participant 1′ and the central participant 1z. As already noted for FIG. 8, no switchover of a multiplexer occurs here.

1. A participant (1) of a communication system,
having a first communication path (10) and a second communication path (20), the communication paths in the communication system preferably with a double-ring topology that operates in contrary directions,
and the participant (1) furthermore includes a first processing unit (11) for processing information signals, obtained via the first communication path (10), and/or for generating and sending information signals via the first communication path, and a second processing unit (21), for processing information signals received via the second communication path (20) and/or for generating and sending information signals via the second communication path,
and furthermore, a first activatable coupling (13, 22) is located in the participant between the first communication path (10) and the second communication path (20), such that upon activation of the first activatable coupling, information signals are picked up from the first communication path (10) and delivered to the second communication path (20), the delivery to the first activatable coupling in the participant (1) being located downstream in the signal travel direction of the processing unit (21) of the second communication path (20),
wherein
the processing unit (11, 21) checks the input signal for its presence, and one phase locked loop per communication path is provided in the participant (1) for phase preparation of the received information signal.

2. The participant in accordance with claim 1,
wherein the pickup of the first activatable coupling is located in the participant downstream in the signal travel direction of the processing unit (11) of the first communication path (10).

3. The participant in accordance with claim 1,
wherein the first activatable coupling includes a first intermediate connecting line (13), for connecting the first communication path (10) to the second communication path (20), and a first switchover element (22), inserted into both the first intermediate connecting line (13) and the second communication path (20).

4. The participant in accordance with claim 3,
wherein the first switchover element (22) is a multiplexer with two inputs and one output, and the inputs are switchable selectively to the output.

5. The participant in accordance with claim 1, wherein the processing units (11, 21) are microprocessor systems for protocol processing, preferably for HDLC processing.

6. The participant in accordance with claim 1, wherein a second activatable coupling (23, 12) is also located in the participant (1), between the first communication path (10) and the second communication path (20), such that upon activation of the second activatable coupling, information signals are picked up from the second communication path (20) and delivered to the first communication path (10), and
wherein the delivery to the second activatable coupling is located downstream in the signal travel direction of the processing unit (11) of the first communication path (10),
and furthermore, the pickup of the second activatable coupling is expediently located downstream in the participant in the signal travel direction of the processing unit (21) of the second communication path (20).

7. The participant in accordance with claim 6,
wherein the second activatable coupling includes an intermediate connecting line (23) for connecting the second communication path (20) to the first communication path (10) and a second switchover element (22), inserted into both the intermediate connecting line (23) and the first communication path (10), and the second switchover element (12) is expediently a multiplexer with two inputs and one output, and the inputs are selectively switchable to the output.

8. The participant in accordance with claim 1, wherein one receiver per communication path, preferably an optical receiver, is provided in the participant for receiving and coupling in the information signals from the communication path into the participant.

9. The participant in accordance with claim 1, wherein one decoupling unit per communication path, preferably a light-emitting diode with a trigger circuit, is provided in the participant for decoupling the information signals from the participant into the communication path.

10. The participant in accordance with claim 1, wherein the participant is a secondary participant (1′, 1″) of the communication system.

11. The participant in accordance with claim 1, wherein the participant is a central participant (lz) of the communication system.

12. The participant in accordance with claim 1, wherein the participant is integrated into an actuator and/or a sensor, preferably into a drive control unit, and especially preferably into a drive control unit of a control motor.

13. The participant in accordance with claim 1, wherein the input signal of a participant is checked for its presence by means of an edge detection in the participant.

14. The participant in accordance with claim 1, wherein if a signal is absent at its input, a participant generates a zero-bit current for subsequent participants.

15. A communication system (5) for directed communication between participants of the communication system, having one central participant (1z) and at least one secondary participant (1′, 1″),
wherein at least one of the participants is embodied in accordance with claim 1.

16. The communication system in accordance with claim 15,
wherein the communication system is embodied with double-ring topology, with two communication paths (10, 20), each annularly closed.

17. The communication system in accordance with claim 16,
wherein the information signal travel in the two communication paths is effected in contrary directions.

18. The communication system in accordance with claim 15,
wherein the participants are connected to one another via optical waveguides.

19. The communication system in accordance with claim 15,
wherein the communication system is a decentralized control system, having a master-slave structure, preferably for controlling and regulating a plurality of control motors.
